(19) United States
(12) Patent Application Publication
(10) Pub. No.: US 2010/0208545 A1
(43) Pub. Date: Aug. 19, 2010

(54) HIGH-PRESSURE HOMOGENIZING APPARATUS

(75) Inventors: Shigeo Ando, Chiba (JP); Masao Ando, Chiba (JP); Toyoroku Ando, Chiba (JP)

Correspondence Address: KRATZ, QUINTOS & HANSON, LLP, 1420 K Street, N.W., 4th Floor, WASHINGTON, DC, 20005, US

(73) Assignees: Shigeo Ando, Chohshi-shi (JP); Masao Ando, Chohshi-shi (JP); Toyoroku Ando, Chohshi-shi (JP)

(21) Appl. No.: 12/679,394

(22) PCT Filed: Oct. 23, 2007
(86) PCT No.: PCT/JP2007/070601

§ 371 Date: Mar. 22, 2010

(51) Int. Cl. B01F 15/00

(52) U.S. Cl. 366/138

(57) ABSTRACT

A high-pressure homogenizing apparatus, in which a material receiving recess can be easily cleaned without disassembling/assembling a pressurizing mechanism, is provided. The apparatus includes a high-pressure homogenizing mechanism (1) in which a suspension (2) or semisolid (2′) containing a raw material (G) is passed through the orifice (3) to be subdivided; and a material receiving passage (8) communicated with the high-pressure homogenizing mechanism (1). One of the inserting member (5) and the material processing piston (4) is moved relatively to each, thereby the suspension or semisolid including the raw material is transferred into the material receiving passage (8) so as to be subdivided and processed. When the material processing piston is moved back over open end (6a) of the material processing recess, the cleaning liquid (W) is introduced through the material receiving passage into the material processing recess and the inside of the material processing recess is cleaned.

### TECHNICAL FIELD

The present invention relates to a high-pressure homogenizing apparatus, which effectively disperses or emulsify a suspension or a semifluid including a fine solid matter with regard to a food, a condiment, a drink, a chemical, a medicine, a cosmetic, and various synthetic resins, or an raw material for a suspension including fiber cellulose with regard to paper manufacturing; and effectively homogenizes under high pressure and subdivides a raw material for disrupting cellular membrane of a germ, such as a colon bacterium and a yeast, in a liquid or a semifluid; and easily cleans securely an outside of a material processing piston and an inside of a material processing recess arranged at a cylinder, in which the material processing piston is inserted movably, so that the high-pressure homogenizing apparatus can be sanitary; and sustain securely a constant interval of injection of a homogenizing valve as an inner-pressure regulating valve for preventing blocking by solidified materials; and adjust easily an inner pressure, and easily be maintained without damage and a malfunction of the valve.

### BACKGROUND ART

In general, for example in the paper manufacturing, a high-pressure homogenizing apparatus, which disperses and subdivides raw materials in a suspension including fiber cellulose by a high pressure difference so as to pass the suspension through a small-diameter orifice at high speed under high pressure, is provided (Patent Document 1).

### CITATION LIST

Patent Document 1: Japan Patent Application Published No. S60-19921

### SUMMARY OF THE INVENTION

### Objects to be Solved

According to the general high-pressure homogenizing apparatus described in Patent Document 1, the suspension including fiber cellulose as a raw material is high-pressurized and passed a small diameter orifice arranged in a radial direction between corresponding surfaces between a valve seat and a valve body, so as to subdivide the raw material by high pressure difference. The valve is pressed to the valve seat by a driving force for a cylinder having a piston, or by spring force of a spring to adjust an inner pressure. It is difficult to provide the orifice so as to have fine orifice clearance. When the orifice is blocked, the raw material can not be subdivided securely. When the orifice clearance is too wide, the raw material is leaked and passed through the orifice, so that the raw material is subdivided without high accuracy.

Some suspensions have viscosity, and when the viscosity is high, the orifice with a fine clearance is easily blocked. Thus, the raw material cannot be passed, and the raw material cannot be subdivided. When the orifice is blocked, the high-pressure homogenizer has to be disassembled and cleaned inside thereof often. Reassembling after disassembling is required, so that the maintenance is not performed easily.

In the high-pressure homogenizing apparatus described in the cited patent document 1, before supplying suspension of fiber cellulose as a raw material into the high-pressure homogenizing apparatus, the suspension is compressed to be high pressure by high-pressure pump, for example a plunger pump as a pressurizing mechanism. However, if cleaning of the plunger pump is neglected or high-viscosity suspension is processed when such general high-pressure homogenizing apparatus by the cited patent document 1 by using the plunger pump, the orifice is blocked immediately. Thereby, cleaning the inside of the pump is required frequently. For cleaning the pump, cleaning steps of disassembling the pump, cleaning it and reassembling the pump after cleaning are required, so that maintenance for the high-pressure homogenizing apparatus are not performed easily. In industries with regard to a food, a condiment, a drink, a chemical, and a medicine, when the suspension or the semifluid including the raw material is subdivides, cleaning the inside of the high-pressure homogenizing apparatus is very important action in view of maintaining cleanliness and preventing uncleanliness.

According to the above problems, an object of the present invention is to provide a high-pressure homogenizing apparatus subdividing a raw material effectively, which can supply a cleaning water from outside by relationally moving a material processing piston or an inserted member structuring a pressurizing mechanism, so that an inside of a material receiving recess can be cleaned easily and securely without large-area disassembling/reassembling, and the high-pressure homogenizing apparatus can be sanitary; and have good maintainability and sustain a fine gap of the orifice securely without blocking the orifice of the high-pressure homogenizing apparatus.

### How to Attain the Object of the Present Invention

In order to overcome the above problems and attain the object of the present invention, a high-pressure homogenizing apparatus, for subdividing/homogenizing one of a suspension and a semifluid including a raw material structured with one of fiber cellulose and fine solid matter by passing one of the suspension and the semifluid through an orifice of a high-pressure homogenizing mechanism, includes a material processing piston; a material processing recess provided at an inserting member so as to insert a top end of the material processing piston; a pressurizing mechanism pressurizing one of the material processing piston and the inserting member; and a material receiving passage communicating between the material processing recess and the high-pressure processing mechanism, and the one of the suspension and the semifluid including the raw material is transferred by pressure into the material receiving passage by volume reduction resulted by relative motion of the inserting member and the material processing piston, and the raw material is subdivided/homogenized, and an inside of the material receiving recess is cleaned by supplying a cleaning liquid from the material receiving passage into the material receiving recess when the material processing piston moves back over an open end of the material processing recess.

According to the present invention, the material processing piston is arranged movably against the inserting member so as to clean the inside of the material processing recess when the material processing piston is moved to a most retracted position near to the open end' of the material processing recess.

According to the present invention, a movable cylinder of the pressurizing mechanism is arranged as the inserting member movably against the material processing piston, which is fixed, so as to clean the inside of the material processing recess when an open end of the material processing recess is moved back to a most retracted position against a top end of the material processing piston.

According to the present invention, the inside of the material processing recess is cleaned when the material processing piston is moved back and pulled out from the open end of the material processing recess.

According to the present invention, the material processing recess is arranged at a cylinder as the inserting member fixed at a base frame, and the material processing piston is inserted movably into the material processing recess by the pressurizing mechanism.

According to the present invention, the material processing recess is arranged at a cylinder as the inserting member fixed at a longitudinal base frame, and the material processing piston is inserted movably into the material processing recess by the pressurizing mechanism, and a liquid pool member with a dish-shaped cross-section is arranged to be fitted around a lower step at a middle portion of the material processing piston, the lower step facing the open end of the material processing recess.

According to the present invention, the material processing recess is arranged at a cylinder as the inserting member fixed at a longitudinal base frame, and the material processing piston is inserted movably into the material processing recess by the pressurizing mechanism.

According to the present invention, the cleaning liquid is supplied to the material receiving recess through a cleaning liquid inlet, which is arranged openably by an open/close device so as to communicate with the material receiving passage, and from the cleaning liquid inlet through the material processing recess in communication with the material receiving passage.

According to the present invention, the cleaning liquid is as one selected among from cleaning water, a disinfectant, and an organic solvent.

According to the present invention, a seal assembly supporting the material processing piston movably and water-tightly is arranged in the material processing recess provided at the inserting member, and assembled by piling a plurality of gaskets.

According to the present invention, the material processing piston is inserted slidably in the seal assembly and the seal assembly is fixed and received in the material processing recess.

According to the present invention, the seal assembly is received and fixed in the material processing recess and the material processing piston is inserted and supported slidably through the seal assembly.

### EFFECTS OF THE INVENTION

According to the present invention, the high-pressure homogenizing apparatus, for subdividing/homogenizing one of the suspension and the semifluid including the raw material structured with one of fiber cellulose and fine solid matter by passing one of the suspension and the semifluid through the orifice of the high-pressure homogenizing mechanism, includes the material processing piston; the material processing recess provided at the inserting member so as to insert the top end of the material processing piston; the pressurizing mechanism pressurizing one of the material processing piston and the inserting member; and the material receiving passage communicating between the material processing recess and the high-pressure processing mechanism, and the one of the suspension and the semifluid including the raw material is transferred by pressure into the material receiving passage by volume reduction resulted by relative motion of the inserting member and the material processing piston, and the raw material is subdivided/homogenized, and the inside of the material receiving recess can be cleaned by supplying a cleaning liquid from the material receiving passage into the material receiving recess when the material processing piston moves back over the open end of the material processing recess. By a simple operation of moving the material processing piston or inserting member structuring the pressurizing mechanism relatively, a space between the material processing piston and the inserting member larger than a normal driving space as a volume at normal driving stroke is generated and cleaning liquid is supplied from the outside of the apparatus, so that the inside of the material receiving recess can be cleaned easily and securely by the cleaning liquid without almost whole disassembling and reassembling. Thus, the apparatus can be maintained sanitary; and have a good maintainability and good manageability. The material receiving passage and the inside of the material receiving recess arranged in the pressurizing mechanism in communication with the orifice in the high-pressure homogenizing apparatus can be cleaned, so that the orifice can be prevented from blocking and a fine gap of the orifice can be maintained easily, and it can contribute to effectively subdivide and high-pressure homogenize the raw material.

According to the present invention, the material processing piston is arranged movably against the inserting member so as to clean the inside of the material processing recess when the material processing piston is moved to a most retracted position near to the open end of the material processing recess. Thereby, when periodical simplified cleaning is acted, by firstly moving the material processing piston back to the most retracted position near to the open end of the material processing recess, a space larger than the normal driving space as the volume at normal driving stroke is generated in the material processing recess. After that, by operating the open/close device, a cleaning liquid inlet is opened. Thereby, a cleaning liquid is supplied from the cleaning liquid inlet through the material receiving passage into the material processing recess. Thus, in a condition that the material processing piston is sustained to be inserted in the material processing recess without pulling the material processing piston out from the most retracted position near to the open end of the material processing recess, the material receiving passage in communication with the gap of the orifice of the high-pressure homogenizing apparatus and the material processing recess can be cleaned rapidly and securely with the cleaning liquid without disassembling/reassembling. As mentioned above, the material receiving passage in communication with the orifice of the high-pressure homogenizing apparatus and the inside of the material receiving recess can be cleaned, so that the orifice can be prevented from blocking and the fine gap of the orifice can be maintained easily, and it can contribute to effectively subdivide and high-pressure homogenize the raw material.

According to the present invention, the movable cylinder of the pressurizing mechanism is arranged as the inserting member movably against the material processing piston, which is fixed, so as to clean the inside of the material processing recess when an open end of the material processing recess is moved back to the most retracted position against the top end of the material processing piston. Thereby, when periodical simplified cleaning is acted, by firstly moving the inserting member back so as to position the top of the material processing piston at the most retracted position near to the open end of the material processing recess, the space larger than the normal driving space as the volume at normal driving stroke is generated in the material processing recess. After that, by operating the open/close device, the cleaning liquid inlet is opened. Thereby, a cleaning liquid is supplied from the cleaning liquid inlet through the material receiving passage into the material processing recess. Thus, in a condition that the material processing piston is sustained to be inserted in the material processing recess without pulling the material processing piston out from the most retracted position near to the open end of the material processing recess, the material receiving passage in communication with the gap of the orifice of the high-pressure homogenizing apparatus and the material processing recess can be cleaned rapidly and securely with the cleaning liquid without disassembling/reassembling. As mentioned above, the material receiving passage in communication with the orifice of the high-pressure homogenizing apparatus and the inside of the material receiving recess can be cleaned, so that the orifice can be prevented from blocking and the fine gap of the orifice can be maintained easily, and it can contribute to effectively subdivide and high-pressure homogenize the raw material.

According to the present invention, the inside of the material processing recess is cleaned when the material processing piston is moved back and pulled out from the open end of the material processing recess. When complete cleaning is acted, firstly the material processing piston is moved back and pulled out from the open end of the material processing recess. After that, by operating the open/close device, the cleaning liquid inlet is opened. Thereby, a cleaning liquid is supplied from the cleaning liquid inlet through the material receiving passage into the material processing recess, and the material receiving passage in communication with the orifice of the high-pressure homogenizing apparatus and the inside of the material processing recess can be cleaned rapidly and securely. Since the material processing piston is moved back and pulled out from the open end of the material processing recess, by supplying the cleaning liquid from the opening into the material processing recess, the material receiving passage in communication with the orifice of the high-pressure homogenizing apparatus and the inside of the material processing recess can be cleaned.

According the present invention, the material processing recess is arranged at the cylinder as the inserting member fixed at the base frame, and the material processing piston is inserted movably into the material processing recess by the pressurizing mechanism. Thereby, when periodical simplified cleaning or complete cleaning is acted, firstly the material processing piston is moved back to the most retracted position near to the open end of the material processing recess, or moved back and pulled out from the material receiving recess. Thereby, the space larger than the normal driving space as the volume at normal driving stroke is generated in the material processing recess. After that, by operating the open/close device, the cleaning liquid inlet is opened. Thereby, a cleaning liquid is supplied from the cleaning liquid inlet through the material receiving passage into the material processing recess, so that the material receiving passage and the material processing recess can be cleaned with cleaning liquid. Thus, when periodical simplified cleaning is acted, in a condition that the material processing piston is sustained to be inserted in the material processing recess without pulling the material processing piston out from the most retracted position near to the open end of the material processing recess, the material receiving passage in communication with the gap of the orifice of the high-pressure homogenizing apparatus and the material processing recess can be cleaned rapidly and securely with the cleaning liquid without disassembling/reassembling. When complete cleaning is acted by moving back and pulling out the material processing piston from the material receiving recess of the inserting member, the cleaning liquid is supplied from the cleaning liquid inlet opened by operating the open/close device, and the cleaning liquid cleans the material receiving passage and the material processing recess. Contaminated cleaning liquid after cleaning is flown out to outside through the material processing recess, which the material processing piston is pulled out. As mentioned above, the material receiving passage in communication with the orifice of the high-pressure homogenizing apparatus and the inside of the material receiving recess can be cleaned, so that the orifice can be prevented from blocking and the fine gap of the orifice can be maintained easily, and it can contribute to effectively subdivide and high-pressure homogenize the raw material.

According to the present invention, the material processing recess is arranged at the cylinder as the inserting member fixed at the longitudinal base frame, and the material processing piston is inserted movably into the material processing recess by the pressurizing mechanism, and the liquid pool member with the dish-shaped cross-section is arranged to be fitted around the lower step at the middle portion of the material processing piston, the lower step facing the open end of the material processing recess. Suspension including the raw material, which leaks through an outer surface of the material processing piston, and cleaning liquid, which is contaminated by cleaning the inside of the material processing recess when complete cleaning is acted by moving back and pulling out the material processing piston from the open end of the material processing recess, are collected in the liquid pool member with the dish-shaped cross-section so as to be prevented from flowing and dropping, so that a hydraulic circuit in the pressurizing mechanism can be prevented from contamination.

According to the present invention, the material processing recess is arranged at the cylinder as the inserting member fixed at the longitudinal base frame, and the material processing piston is inserted movably into the material processing recess by the pressurizing mechanism. Thereby, when periodical simplified cleaning or complete cleaning is acted, firstly the material processing piston is moved back to the most retracted position near to the open end of the material processing recess, or moved back and pulled out from the material receiving recess. Thereby, the space larger than the normal driving space as the volume at normal driving stroke is generated in the material processing recess. After that, by operating the open/close device, the cleaning liquid inlet is opened. Thereby, a cleaning liquid is supplied from the cleaning liquid inlet through the material receiving passage into the material processing recess, so that the material receiving passage and the material processing recess can be cleaned with cleaning liquid. Thus, when periodical simplified cleaning is acted, in a condition that the material processing piston is sustained to be inserted in the material processing recess without pulling the material processing piston out from the most retracted position near to the open end of the material processing recess, the material receiving passage in communication with the gap of the orifice of the high-pressure homogenizing apparatus and the material processing recess can be cleaned rapidly and securely with the cleaning liquid without disassembling/reassembling. When complete cleaning is acted by moving back and pulling out the material processing piston from the material receiving recess of the inserting member, the cleaning liquid is supplied from the cleaning liquid inlet opened by operating the open/close device, and the cleaning liquid cleans the material receiving passage and the material processing recess. Contaminated cleaning liquid after cleaning is flown out to outside through the material processing recess, which the material processing piston is pulled out. As mentioned above, the material receiving passage in communication with the orifice of the high-pressure homogenizing apparatus and the inside of the material receiving recess can be cleaned, so that the orifice can be prevented from blocking and the fine gap of the orifice can be maintained easily, and it can contribute to effectively subdivide and high-pressure homogenize the raw material.

According to the present invention, the cleaning liquid is supplied to the material receiving recess through the cleaning liquid inlet, which is arranged openably by an open/close device so as to communicate with the material receiving passage, and from the cleaning liquid inlet through the material processing recess communicated with the material receiving passage. By operating the open/close device to be opened, fresh cleaning liquid can be supplied from the cleaning liquid inlet to the material receiving passage and the material processing recess.

According to the present invention, the cleaning liquid is as one selected among from cleaning water, a disinfectant, and an organic solvent. The cleaning liquid can be selected from among cleaning water, disinfects and organic solvents according to the raw material of the suspension or the semifluid including fine solid matter or fiber cellulose, so that the material processing piston and the material processing recess arranged at the inserting member can be cleaned by the cleaning liquid and disinfected by the disinfectant.

According to the present invention, the seal assembly supporting the material processing piston movably and water-tightly is arranged in the material processing recess provided at the inserting member, and assembled by piling the plurality of gaskets. Thereby, when the raw material structures by the suspension or the semifluid supplied into the material processing recess arranged at the inserting member is subdivided and high-pressure homogenized by passing the raw material through the orifice provided at the high-pressure homogenizing mechanism, the raw material is pressurized and compressed so as to reduce its volume by the material processing piston waterproofed under high pressure.

According to the present invention, the material processing piston is inserted slidably in the seal assembly and the seal assembly is fixed and received in the material processing recess. Thereby, when the raw material structures by the suspension or the semifluid supplied into the material processing recess arranged at the inserting member is subdivided and high-pressure homogenized by passing the raw material through the orifice provided at the high-pressure homogenizing mechanism, the raw material is pressurized and compressed so as to reduce its volume by the material processing piston waterproofed under high pressure. When the complete cleaning is acted, the seal assembling is pulled together with the material processing piston pulled out from the material processing recess at the inserting member. Thus, the seal assembly is cleaned together with the material processing piston by the cleaning liquid. The high-pressure homogenizing apparatus is sanitary. Since the seal assembling is provided at the material processing piston, the material processing piston cab be easily assembled through the seal assembly into the material receiving section, so that working property is improved.

According to the present invention, the seal assembly is received and fixed in the material processing recess and the material processing piston is inserted and supported slidably through the seal assembly. Thereby, when the raw material structures by the suspension or the semifluid supplied into the material processing recess arranged at the inserting member is subdivided and high-pressure homogenized by passing the raw material through the orifice provided at the high-pressure homogenizing mechanism, the raw material is pressurized and compressed so as to reduce its volume by the material processing piston waterproofed under high pressure.

### BRIEF DESCRIPTION OF THE DRAWINGS

FIG. 1 is a cross-sectional view of a first embodiment of a high-pressure homogenizing apparatus according to the present invention;

FIG. 2 is a cross-sectional view of the high-pressure homogenizing apparatus, shown in FIG. 1, compressing in high pressure and subdividing a material received in a material receiving recess provided at an inserting member by a material processing piston;

FIG. 3 is a cross-sectional view of a condition that the material processing piston is pulled out from the material receiving recess provided at the inserting member for complete cleaning in the high-pressure homogenizing apparatus shown in FIG. 1;

FIG. 4 is an expanded cross-sectional view showing in detail the high-pressure homogenizing mechanism of the first embodiment of the high-pressure homogenizing apparatus shown in FIG. 1;

FIG. 5 is an expanded cross-sectional view showing one example of a seal assembly in assembled condition, structuring the high-pressure homogenizing apparatus according to the first embodiment shown in FIG. 1;

FIG. 6 is an expanded cross-sectional view showing the other example of the seal assembly in assembled condition, structuring the high-pressure homogenizing apparatus according to the first embodiment shown in FIG. 1;

FIG. 7 is a cross-sectional view of a second embodiment of the high-pressure homogenizing apparatus according to the present invention;

FIG. 8 is a cross-sectional view of the high-pressure homogenizing apparatus, shown in FIG. 7, compressing in high pressure and subdividing a material received in a material receiving recess provided at an inserting member by a material processing piston;

FIG. 9 is a cross-sectional view of a condition that the material processing piston is pulled out from the material receiving recess provided at the inserting member for complete cleaning in the high-pressure homogenizing apparatus shown in FIG. 7;

FIG. 10 is a cross-sectional view of a third embodiment of the high-pressure homogenizing apparatus according, to the present invention;

FIG. 11 is a cross-sectional view of the high-pressure homogenizing apparatus, shown in FIG. 10, compressing in high pressure and subdividing a material received in a material receiving recess provided at an inserting member by a material processing piston;

FIG. 12 is a cross-sectional view of a condition that the material processing piston is pulled out from the material receiving recess provided at the inserting member for complete cleaning in the high-pressure homogenizing apparatus shown in FIG. 10;

FIG. 13 is a cross-sectional view of a fourth embodiment of the high-pressure homogenizing apparatus according to the present invention;

FIG. 14 is a cross-sectional view of the high-pressure homogenizing apparatus, shown in FIG. 13, compressing in high pressure and subdividing a material received in a material receiving recess provided at an inserting member by a material processing piston; and

FIG. 15 is a cross-sectional view of a condition that the material processing piston is pulled out from the material receiving recess provided at the inserting member for complete cleaning in the high-pressure homogenizing apparatus shown in FIG. 13.

### REFERENCE SIGNS LIST

1 High-pressure homogenizing mechanism
2 Suspension
2′ Semifluid
3 Orifice
4 Material processing piston
4a Top end
5 Inserting member
6 Material processing recess
6a Open end
7 Pressurizing mechanism
8 Material receiving passage
9 Pressurizing cylinder
10 Base frame
11 Cylinder member
11′ Movable cylinder
12 Cleaning liquid inlet
13 Open/close device
16 Seal assembly
18 Material supply hopper
20 Material collecting hopper
G Raw material
I Driving stroke
S Space
W Cleaning liquid

### DESCRIPTION OF EMBODIMENTS

### First Embodiment

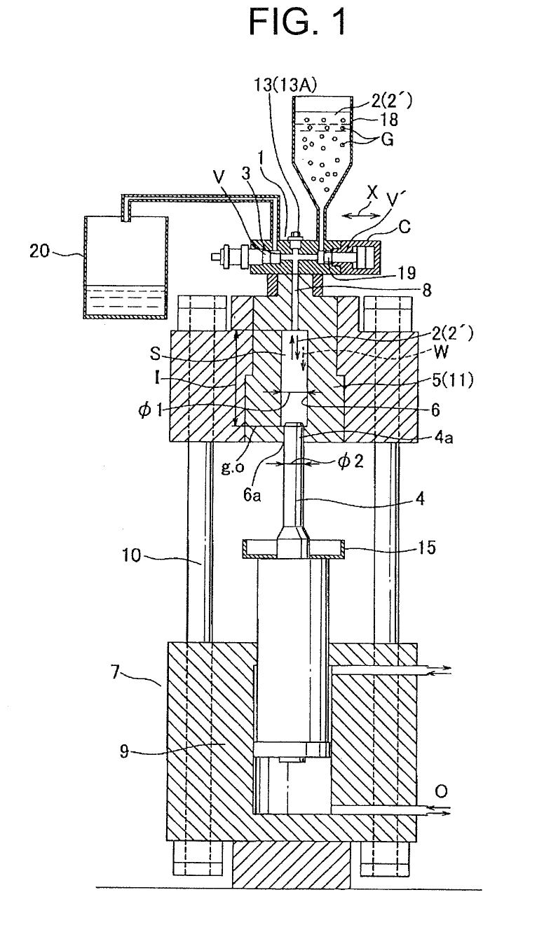

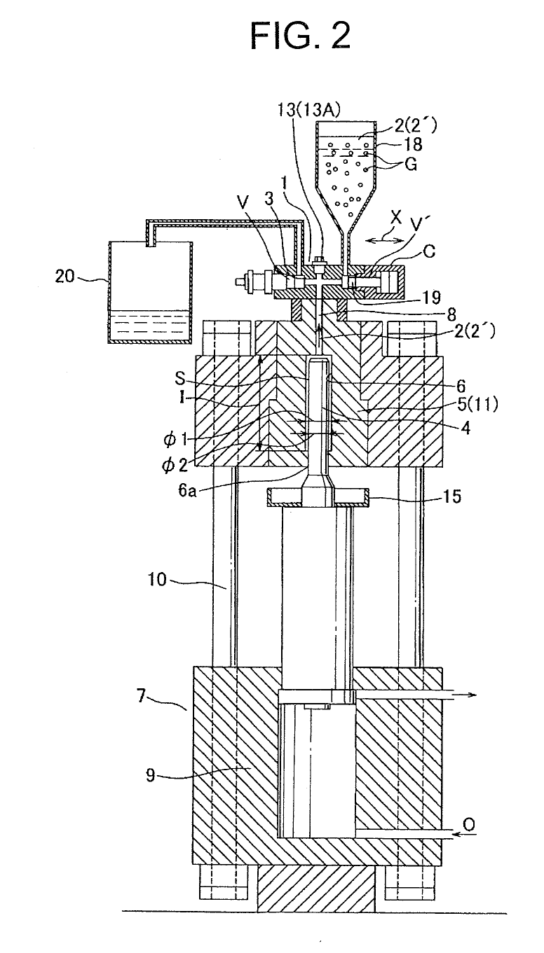

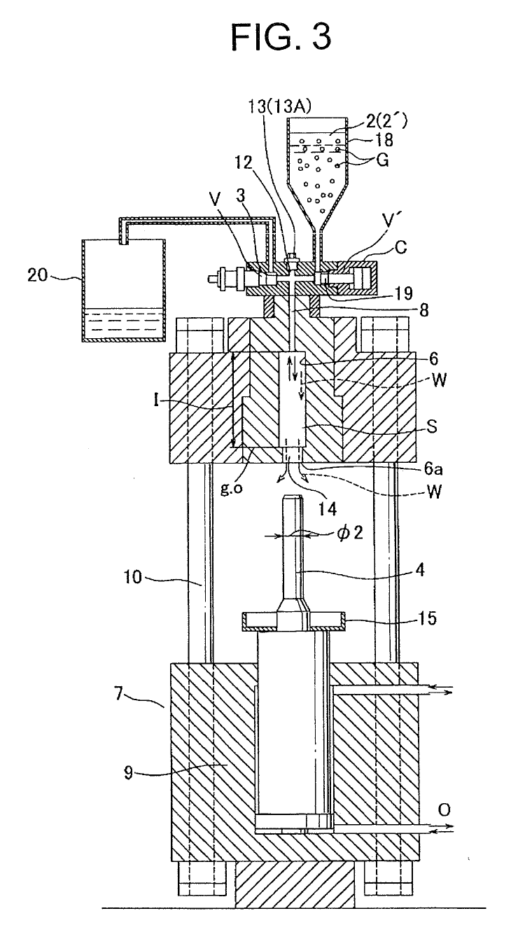

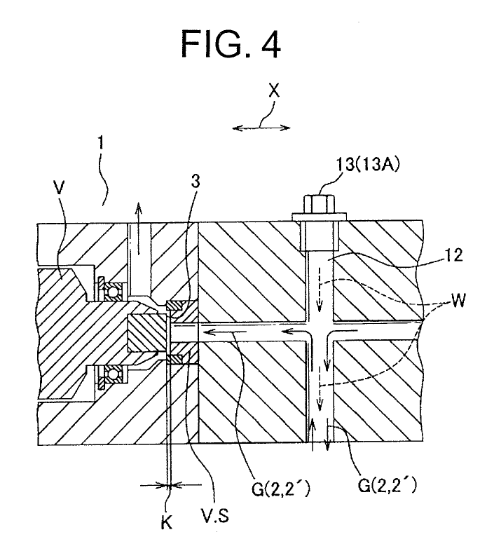

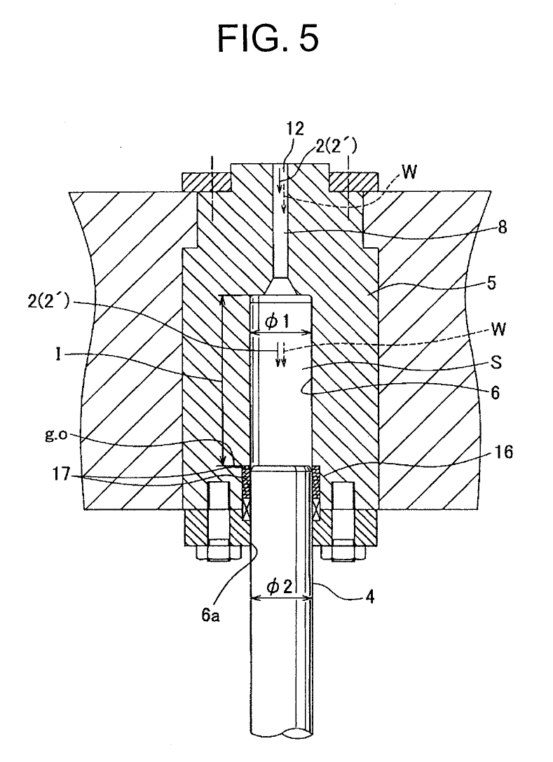

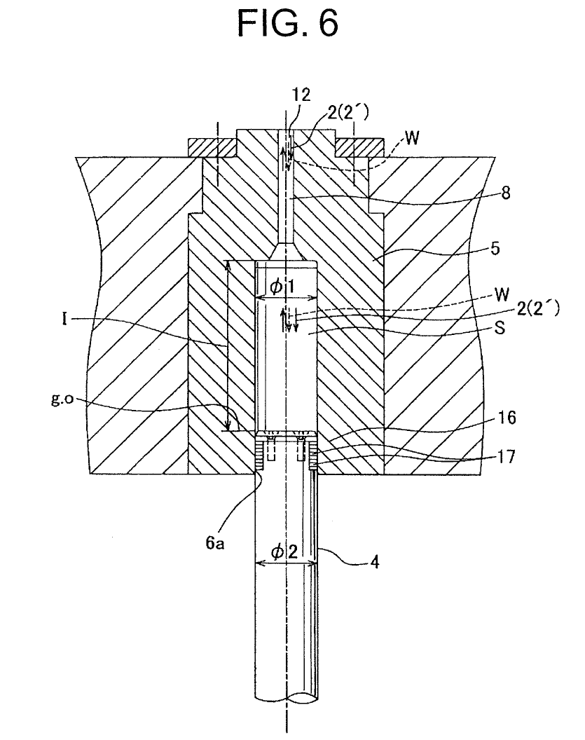

A suitable embodiment according to the present invention will be described with reference to following drawings. FIG. 1 is a cross-sectional view of a first embodiment according to the present invention. FIG. 2 is a cross-sectional view of the high-pressure homogenizing apparatus, shown in FIG. 1, compressing in high pressure and subdividing a material received in a material receiving recess provided at an inserting member by a material processing piston. FIG. 3 is a cross-sectional view of a condition that the material processing piston is pulled out from the material receiving recess provided at the inserting member for complete cleaning in the high-pressure homogenizing apparatus shown in FIG. 1. FIG. 4 is an expanded cross-sectional view showing in detail the high-pressure homogenizing mechanism of the first embodiment of the high-pressure homogenizing apparatus shown in FIG. 1. FIG. 5 is an expanded cross-sectional view showing one example of a seal assembly in assembled condition, structuring the high-pressure homogenizing apparatus according to the first embodiment shown in FIG. 1. FIG. 6 is an expanded cross-sectional view showing the other example of the seal assembly in assembled condition, structuring the high-pressure homogenizing apparatus according to the first embodiment shown in FIG. 1.

A high-pressure homogenizing apparatus according to the first embodiment subdivides or high-pressure homogenizes suspension 2 or a semifluid 2′ including a raw material G structured with one of fiber cellulose and fine solid matter by passing one of the suspension 2 and the semifluid 2′ through an orifice 3 of a high-pressure homogenizing mechanism 1, and includes a material processing piston 4; a material processing recess 6 provided at an inserting member 5 so as to insert a top end 4a of the material processing piston 4; a pressurizing mechanism 7 pressurizing one of the material processing piston 4 and the inserting member 5; and a material receiving passage 8 communicating between the material processing recess 6 and the high-pressure processing mechanism 1, and the one of the suspension 2 and the semifluid 2′ including the raw material G is transferred by pressure into the material receiving passage 8 by volume reduction resulted by relative motion of the inserting member 5 and the material processing piston 4, and the raw material G is subdivided/homogenized, and an inside of the material receiving recess 6 is cleaned by supplying a cleaning liquid W from the material receiving passage 8 into the material receiving recess 6 when the material processing piston 4 moves back over an open end 6a of the material processing recess 6.

In the high-pressure homogenizing apparatus, a homogenizing valve is moved linearly in an X-axial direction by a hydraulic cylinder (not shown) so as to change a fine gap K of an orifice 3 against a valve seat VS, so that an inner pressure subdividing the raw material G by passing the raw material G through the gap K of the orifice 3 is adjusted (FIG. 4).

The orifice is formed with the fine gap K not larger than 1/100 mm. Thereby, the raw material G is prevented from leaking unexpectedly, so that the raw material G can be subdivided accurately.

The orifice 3 is adjusted to make the inner pressure 100 MPa, preferably 280 MPa. Thereby, the raw material G is exhausted strongly with high pressure from the orifice 3, so that the raw material G can be subdivided and homogenized securely by a large difference of pressure.

As the raw material G, a food including starch in a food area, for example, a raw rice seed as a solid matter in a rice cake and a rice cracker; a buckwheat seed in buckwheat noodles; a wheat in a bread, a pie and noodle; various cereals, such as a soybean, and an adzuki-bean in a soybean curd, soy milk, soy sauce and a miso as a seasoning are listed. Also, fruit and various vegetables in jam, fruit wine and juice are listed. And various vegetable oil; milk in butter, yogurt and dairy products; and tea leaf in green tea and black tea, bean in coffee; and barley corn and hop in beer are listed. In soups, infant food, emergency food, hospital food, nutrition food, and space food, solid matters as a source of nutrition is listed; and various compounds, fiber cellulose and casein, as solid matters provided in the suspension 2 and the semi-liquid 2′ as semi-finished products or finished products for improving prevention of separation, long-term stability, flavor, and feeling of a drink are listed. Also, in chemicals, cosmetics and industrial products, various pigments, magnetic powder, minerals and carbon powder as solid matters provided in suspension 2, emulsion, or semifluid 2′ as semi-finished products and finished products are listed. In medicine, minerals and herbal medicine as solid matters provided in suspension 2, emulsion or semifluid 2′ as semi-finished products and finished products are listed. In the glass industry, pigments and minerals as fine solid matters provided in a glass liquid are listed. In plastics industry, pigments, carbon, minerals, plasticizers, reinforcing fiber, and inorganic material such as ceramic provided in liquid body of thermoplastic resin, that is in suspension 2, emulsion or semifluid 2′ as semi-finished products and finished products are listed. In paper industry, fiber cellulose as a solid matter provided in suspension 2 or emulsion, semifluid 2′ is listed. In various pathology laboratories, cells of germs, such as coliform bacillus and yeast, provided in suspension 2 or semifluid 2′ are listed.

In the embodiment, the pressurizing mechanism 7, as shown, includes a pressurizing cylinder 9, in which a circuit flowing oil O or water therein is arranged, and the material processing piston 4, the top end 4a of which is inserted slidably in the material processing recess 6 arranged at the inserting member 5. The material processing piston 4 is arranged slidably in the pressurizing cylinder 9 and corresponding to and slidably in a cylinder member 11 as the inserting member 5, which is fixed at a top end of the base frame 10 as shown in FIGS. 1-3. The pressurizing mechanism 7 leads the suspension 2 or semifluid 2′ including the raw material G into the material processing recess 6 arranged at the inserting member and pressurizes the material processing piston 4 to decrease a volume so as to transfer the raw material G to the orifice 3 by high pressure of not less than 100 MPa, preferably 280 MPa, so that the raw material G is passed through the fine gap pg the orifice 3 formed between the valve seat VS and the homogenizing valve V and subdivided by, large difference of pressure.

An inner diameter φ1 and a length of the material processing recess, an outer diameter φ2 and a length of the material processing piston 4 to be inserted into the material processing recess 6 are designed suitably under consideration of a volume of the suspension 2 or the semifluid 2′ including the raw material G so as to be transferred to the orifice 3 by high pressure and subdivided or homogenized.

A clearing liquid inlet 12 is provided openably by an open/close device 13 at the high-pressure homogenizing mechanism 1 so as to communicate with the material receiving passage 8. The material receiving passage 8 communicates with the material processing recess 6. The open/close device 13 is opened so that the cleaning liquid W is led from the outside in the cleaning liquid inlet 12 and led from the cleaning liquid inlet 12 through the material receiving passage 8 into the material processing recess 6.

As the cleaning liquid, one of cleaning water, a disinfectant, and an organic solvent is provided. The cleaning liquid is selected from among of cleaning water, a disinfectant, and an organic solvent correspondingly to a king of the raw material in the suspension 2 or the semifluid 2′ including fine solid matters, or fiber cellulose. Thereby, the material processing piston 4 and the material processing recess 6 arranged at the inserting member 5 are cleaned with the cleaning liquid W.

In the high-pressure homogenizing apparatus according to the first embodiment, when the material processing recess 6 and the material receiving passage 8 in communication with the material processing recess 6 are cleaned with the cleaning liquid W, following two methods selecting and adjusting a moving stroke of the material processing piston 4 according to cleaning level are considered for generating a wide space S over a moving stroke I of usual driving.

In the high-pressure homogenizing apparatus according to the first embodiment, a first method is cleaning under a condition of moving the material processing piston 4 in the material processing recess 6 to a most retracted position g.o near to the open end 6a of the material processing recess 6 without disassemble/reassemble when cleaning is acted after an operation of high-pressure homogenizing, or simple cleaning is acted with a predetermined period, or monthly or periodically, the material processing piston 4 (FIG. 1). A second method is cleaning under a condition of moving back and pulling out the material processing piston 4 from the open end 6a of the material processing recess 6 so as to disassemble the pressurizing mechanism 7 when complete cleaning of an inside of the material processing recess 6 is acted (FIG. 3).

When simple cleaning according to the first method is acted, the pressurizing cylinder 9 of the pressuring mechanism 7 is driven so as to move back the material processing piston 4 to the most retracted position g.o near to the open end 6a of the material processing recess 6. Thereby, the material processing piston 4 is moved in the material processing recess 6 over the moving stroke I of the normal driving, so that the wide space. S is generated. Thereafter, the cleaning liquid inlet 12 is opened by operating the open/close device 13. By supplying cleaning liquid W from the cleaning liquid inlet 12 through the material receiving passage 8 into the material processing recess 6, not by pulling out the material processing piston 4 from the most retracted position g.o near to the open end 6a of the material processing recess 6, that is by sustaining the material processing 4 inserted in the material processing recess, the material receiving passage 8 and the inside of the material processing recess 6 can be cleaned rapidly and securely with the cleaning liquid W without work and time of disassembling/reassembling the pressurizing mechanism 7.

The cleaning liquid W is selected from for example, the cleaning water, and the disinfectant corresponding to the raw material G. The organic solvent is applied corresponding to the synthetic resin as the raw material G. When high-pressure water is applied as the cleaning water, dregs or contamination of the raw material G remained in the inside of the material processing recess 6 can be removed by injecting pressure. The cleaning liquid W may be hot.

When complete cleaning according to the second method is acted, first, the pressurizing mechanism 7 is driven so as to pull out and disassemble the material processing piston 4 from the open end 6a of the material processing recess 6 to outside thereof (FIG. 3). The open/close device 13 is operated so as to open the material liquid inlet 12. Thereafter, the cleaning liquid W is led from the cleaning liquid inlet 12 through the material receiving passage 8 into the material processing recess 6. Thereby, the material receiving passage 8 in communication with the gape K of the orifice 3 at the high-pressure homogenizing mechanism 1 and the material processing recess 6 are cleaned rapidly and securely. Since the material processing piston 4 is moved back from the open end 6a of the material processing recess 6 and pulled out to the outside thereof so as to open an opening 14, the cleaning liquid W can be led from the opened opening 14 into the material processing recess 6, so that the material processing recess 6 and the material receiving passage 8 can be cleaned. A water stop bolt 13A is used at the cleaning liquid inlet 12 as shown. Instead of the water stop bolt 13A, a water stop valve, not shown, can be applied so as to automatically open the water stop valve to lead the cleaning liquid W into the inside.

A liquid pool member 15 is formed to have a dish-shaped cross-section and fitted around a lower step at a middle portion of the material processing piston 4, which the lower step faces the open end 6a of the material processing recess 6. The suspension 2 including the raw material G in the liquid W, which leaks through an outer surface of the material processing piston 4, and cleaning liquid W, which is lead from the cleaning liquid inlet 12 and contaminated by cleaning the inside of the material processing recess 6 when complete cleaning is acted by moving back and pulling out the material processing piston 4 from the material processing recess 6, are collected in the liquid pool member 15 so as to prevent a hydraulic circuit in the pressurizing mechanism from contamination. Dimensions and a depth of the liquid pool member 15 is suitably designed corresponding to a volume to receive the cleaning liquid W.

A seal assembly 16 is received in the material processing recess 6 arranged at the inserting member 5 so as to support the material processing piston 4 slidably to be waterproofed. The seal assembly 16 is formed by stacking a plurality of gaskets 17 made of stiff synthetic resin. For passing the suspension 2 or semifluid 2′ as the raw material G through the orifice 3 arranged at the high-pressure homogenizing mechanism so as to subdivide and high-pressure homogenize the raw material G by large difference of pressure, the seal assembly can waterproof to compress under high pressure by the volume reduction by pressurization of the raw material G by the material processing piston 4. In the first embodiment, the seal assembly 16 is received and fixed in the material processing recess 6 as shown in FIG. 5 so as to insert and support the material processing piston 4 slidably therein. Instead, for example, as shown in FIG. 6, the seal assembly 16 can insert the material processing piston 4 slidably, and is fixed and received in the material processing recess 6. When complete cleaning is acted as shown FIG. 3 and the material processing piston 4 is pulled out from the material processing recess 6 of the inserting member 5, not only the material processing recess 6 is cleaned by the cleaning liquid W, but also the material processing piston 4 and the seal assembly 16, which is pulled out together with the material processing piston 4, can be cleaned together by wiping out by a brush. Thereby, very disinfectant cleaning can be acted. The material processing piston 4 and the seal assembling 16 are assembled together, so that after cleaning, the material processing piston 4 can be easily assembled through the seal assembly 16 in the material processing recess 6 of the inserting member 5.

A material supply hopper 18 is provided for storing the suspension 2 or the semifluid 2′ including the raw material G so as to supply the suspension 2 or the semifluid 2′ including the raw material G through the material receiving passage 8 into the material processing recess at the high-pressure homogenizing mechanism 1. A material supply control valve 19 is provided so as to control supply/stop of the suspension 2 or the semifluid 2′ including the raw material G. In the shown first embodiment, a cylinder-type valve body, which can move a valve rod V′ forth/back in a direction of axis X by automatically switching the hydraulic circuit, is applied.

A material collecting hopper 20 is connected with a secondary side of the orifice 3 for collecting the suspension 2 or the semifluid 2′ after the raw material included in the suspension 2 or the semifluid 2′ is subdivided and high-pressure homogenized by the orifice 3 at the high-pressure homogenizing mechanism 1.

In the embodiment according to the present invention as structured above, the material supply control valve 19 is opened, and the raw material G of the suspension 2 or the semifluid 2′ including the raw material G, such as fine solid matter, fiber cellulose or cells is sucked through the material receiving passage 8 into the material processing recess 6 according to the material processing piston 4 moving downwardly.

Thereafter, the pressurizing mechanism 7 is driven, and the material processing piston 4 is moved upwardly in the material processing recess 6, so that the raw material G included in the suspension 2 or the semifluid 2′ received in the material processing recess 6 is pressurized by the material processing piston 4, and compressed under high pressure by volume reduction. The raw material G is led through the material inlet 12 into the high-pressure homogenizing mechanism 1, and passed through the small-diameter orifice 3 provided at the high-pressure homogenizing mechanism 1 in high speed under high pressure. Thereby, the raw material G is subdivided or high-pressure homogenized, such as dispersing, emulsifying or disrupting cellular membrane.

At the time, the orifice 3 is formed so as to have the narrow gap K, for example not larger than 1/100 mm, so that the raw material G is not leaked from the orifice 3, and subdividing and processing the raw material G can be acted high efficiently and high precisely.

Since the orifice 3 is formed to have the narrow gap of not larger than 1/100 mm, an inner pressure is adjusted to be not less than 100 MPa, furthermore 280 MPa. Thereby, the raw material G is injected with high pressure from the orifice 3. Thus, the raw material G can be subdivided or high-pressure homogenized securely by the large difference of pressure.

After the raw material G is subdivided and high-pressure homogenized, the hydraulic circuit of the pressurizing mechanism 7 is switched and the material processing piston 4 is moved downwardly back to a previous position (condition shown in FIG. 1) in the material processing recess 6. The material supply control valve 19 is opened, and the suspension 2 or the semifluid 2′ including the raw material G is sucked through the material receiving passage 8 into the material processing recess 6 for a next process. The above operations are repeated so that the subdividing and high-pressure homogenizing of the raw material G are acted continuously.

In the high-pressure homogenizing apparatus according to the first embodiment, the cleaning method for the raw material processing recess 6 and the material receiving passage 8 communicating with the raw material processing recess 6 is selected from two cleaning methods by adjusting the moving stroke of the material processing piston 4 corresponding to area of cleaning.

In other words, in the high-pressure homogenizing apparatus according to the first embodiment, when the cleaning is acted after the operation of high-pressure homogenizing, or simple cleaning is acted with a predetermined period, or monthly or periodically, the material processing piston 4 is moved in the material processing recess 6 to the most retracted position g.o near to the open end 6a of the material processing recess 6, so that the wide space S over the moving stroke I of the normal driving, can be generated.

Thereafter, a passage of the cleaning liquid inlet 12 is opened by screwing the water stop bolt 13A as the open/close device 13. The cleaning liquid W is led from the cleaning liquid inlet 12 through the material receiving passage 8 into the material processing recess 6. As shown in FIG. 1, in a condition that the material processing piston 4 is sustained to be inserted in the material processing recess 6 without pulling the material processing piston 4 out from the most retracted position g.o near to the open end 6a of the material processing recess 6, the material receiving passage 8 in communication with the gap of the orifice 3 of the high-pressure homogenizing apparatus 1 and the inside of the material processing recess 6 can be cleaned rapidly and securely with the cleaning liquid without works and time of disassembling/reassembling.

In a condition that the material processing piston 4 is sustained to be inserted in the material processing recess 6 without pulling the material processing piston 4 out from the most retracted position g.o near to the open end 6a of the material processing recess 6, the material receiving passage 8 in communication with the gap K of the orifice 3 at the high-pressure homogenizing mechanism 1 and the inside of the material processing recess 6 can be cleaned rapidly and securely by wiping out the raw material G with the cleaning liquid W by a brush without disassembling the pressurizing mechanism 7 and reassembling the pressurizing mechanism 7 after cleaning. The material receiving passage 9 and the inside of the material processing recess 6, which are arranged in the pressurizing mechanism 7 in communication with the orifice 3 of the high-pressure homogenizing apparatus, can be cleaned, so that the orifice 3 can be prevented from blocking and the fine gap K of the orifice 3 can be sustained easily and securely, and it can contribute to effectively subdivide and high-pressure homogenize the raw material G. Thereby, it is applied suitably to subdividing and homogenizing the raw material in area of high-pressure homogenizing the suspension 2 or the semifluid 2′ including the raw material G especially in industries with regard to a food, a condiment, a drink, a medicine and medical treatment, or subdividing or high-pressure homogenizing the raw material G having high viscosity or area of subdividing and high-pressure homogenizing a cell, which requires high cleanliness.

When complete cleaning is acted, before cleaning, the pressurizing mechanism 7 is driven so as to disassemble by moving back and pulling out the material processing piston 4 from the open end 6a of the material processing recess 6. The cleaning liquid inlet 12 is opened by operating the open/close device 13. Thereafter, the cleaning liquid W is led from the cleaning liquid inlet 12 through the material receiving passage 8 into the material processing recess 6, and flows from the opening 14 of the material processing recess 6, from which the material processing piston 4 is pulled out. The material receiving passage 8 in communication with the gap K of the orifice 3 at the high-pressure homogenizing mechanism 1, and the inside of the material processing recess 6 can by cleaned and dregs or contamination of the raw material G remained in the inside thereof can be removed with the cleaning liquid by wiping with brush. As mentioned above, by supplying the cleaning liquid W upwardly from the opening 14, from which the material processing piston 4 is moved back and pulled out from the open end 6a of the material processing recess 6, the material processing recess 6 and the material receiving passage 8 can be cleaned from a bottom side thereof. Thus, the material receiving passage 8 and the inside of the material processing recess 6 can be cleaned without exception.

Since the material receiving passage 8 arranged at the pressurizing mechanism 7 in communication with the orifice 3 and the material processing recess 6 can be cleaned, the orifice 3 can be prevented from blocking and the fine gap K of the orifice 3 can be maintained easily, and it can contribute to effectively subdivide and high-pressure homogenize the raw material G. Thereby, it is applied suitably to subdividing and homogenizing the raw material in area of high-pressure homogenizing the suspension 2 or the semifluid 2′ including the raw material G in industries with regard to a food, a condiment, a drink, a medicine, medical treatment, and a cell, which require high cleanliness, or subdividing or high-pressure homogenizing the raw material G having high viscosity. By applying the above simple cleaning and the complete cleaning in parallel, the cleaning will be more complete so as to maintain further cleanliness.

In the high-pressure homogenizing apparatus according to the embodiment, two methods for cleaning the material processing recess 6 and the material receiving passage 8 in communication with the material processing recess 6, which are the simple cleaning and the complete cleaning, is selected rapidly and smoothly by adjusting the moving stroke of the material processing piston 4 according to cleaning level. The simple cleaning is acted by moving the material processing piston 4 over the most retracted position g.o near to the open end 6a of the material processing recess 6 without pulling out the material processing piston 4 from the material processing recess 6 and disassembling. The complete cleaning is acted by moving back the material processing piston 4 and pulling out from the open end 6a of the material processing recess 6 and disassembling. When the material processing recess 6 and the material receiving passage 8 are cleaned by the complete cleaning method, the material processing piston 4, which was pulled out from the material processing recess 6, can be reassembled easily into the material processing recess 6 by driving the pressurizing mechanism 1 so as to align an axis of the material processing piston 4 against an axis of the material processing recess 6.

### Second Embodiment

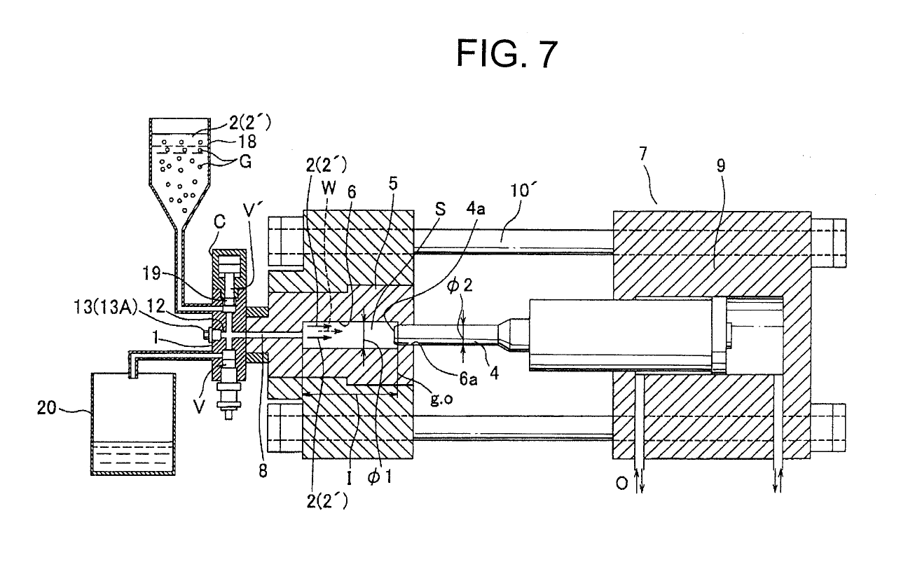

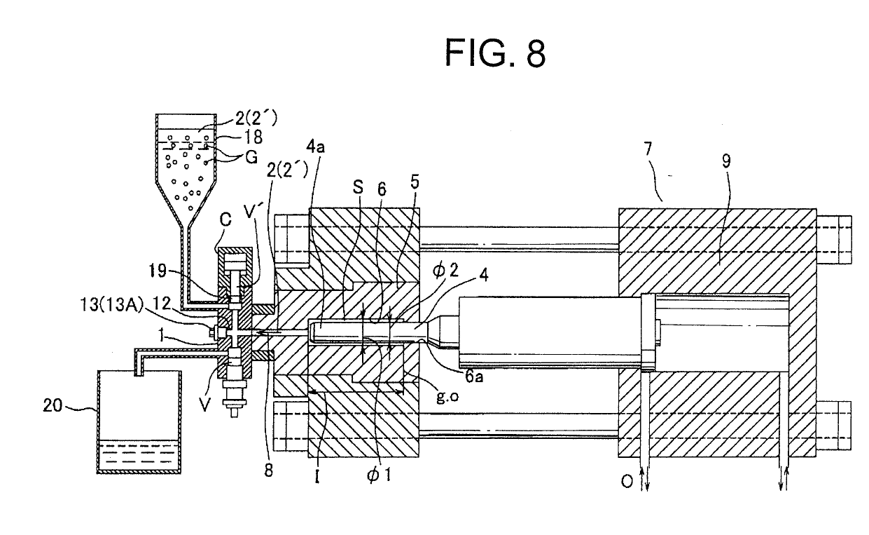

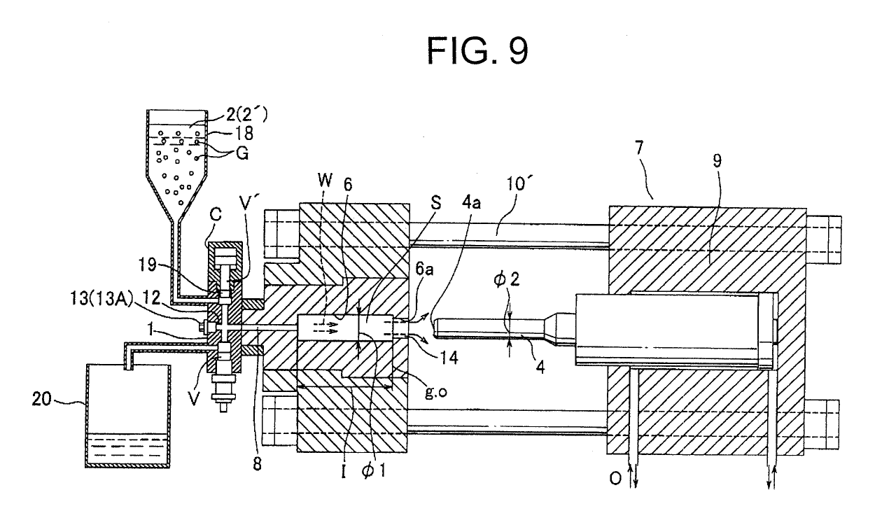

A second embodiment of the high-pressure homogenizing apparatus is shown in FIGS. 7-9. The high-pressure homogenizing apparatus according to the first embodiment is structured vertically, instead of that, the high-pressure homogenizing apparatus according to the second embodiment is structured horizontally, that is difference. Thus, the material processing recess 6 is arranged at a cylinder member as the inserting member 5 fixed at the horizontal base frame 10′, and the material processing piston 4 is inserted in the material processing recess 6 so as to be movably by the pressurizing mechanism 7.

According to the second embodiment, when a periodical simple cleaning is acted, or when a complete cleaning is acted, firstly, the material processing piston 4 is moved back to the most retracted position g.o near to the open end 6a of the material processing recess 6, or the material processing piston is moved back and pulled out from the material processing recess 6 of the inserting member 5. Thus, the space S larger than the volume at the normal driving stroke I of the material processing piston 4 is generated in the material processing recess 6. Thereafter, the cleaning liquid inlet 12 is opened by operating the open/close device 13. The cleaning liquid W is led from the cleaning liquid inlet 12 through the material receiving passage 8 into the material processing recess 6, so that the material receiving passage 8 and the inside of the material processing recess 6 are cleaned with the cleaning liquid W by wiping by the brush.

When the periodical simple cleaning is acted, in a condition that the material processing piston 4 is sustained to be inserted in the material processing recess 6 as shown in FIG. 7 without pulling the material processing piston 4 out from the most retracted position g.o near to the open end 6a of the material processing recess 6, the inside of the material processing recess 6 can be cleaned rapidly and securely by wiping out the raw material G with the cleaning liquid W by a brush without disassembling the pressurizing mechanism 7 and reassembling the pressurizing mechanism 7. When the complete cleaning is acted, in a condition that the material processing piston 4 is pulled out from the material processing recess 6 at the inserting member 5, the contaminated cleaning liquid, which was led from the cleaning liquid inlet 12 opened by opening the open/close device 13 and cleaned the material receiving passage 8 and the inside of the material processing recess 6, is flown out to the outside through the material processing recess 6, which the material processing piston is pulled out. As mentioned in the first embodiment, the material receiving passage 8 in communication with the orifice 3 of the high-pressure homogenizing apparatus and the inside of the material processing recess 6 can be cleaned, so that the orifice 3 can be prevented from blocking and the fine gap K of the orifice 3 can be maintained easily, and it can contribute to effectively subdivide and high-pressure homogenize the raw material.

### Third Embodiment

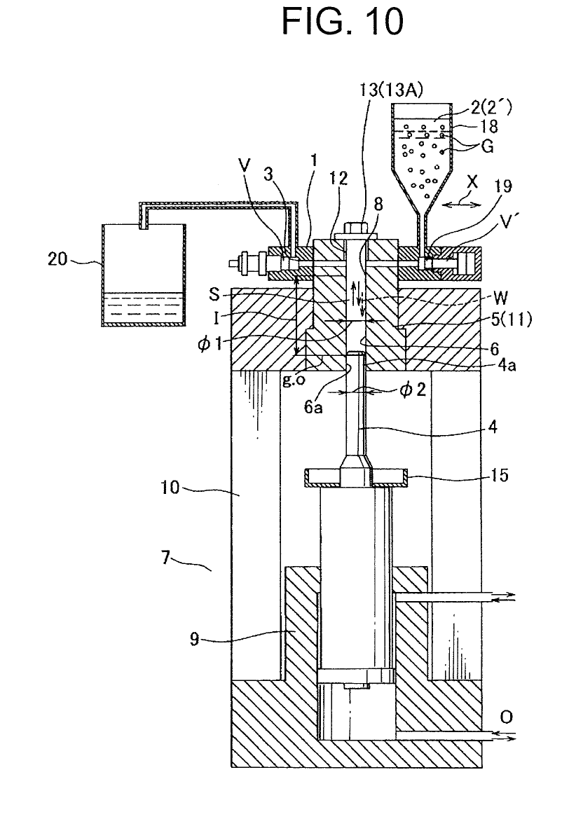

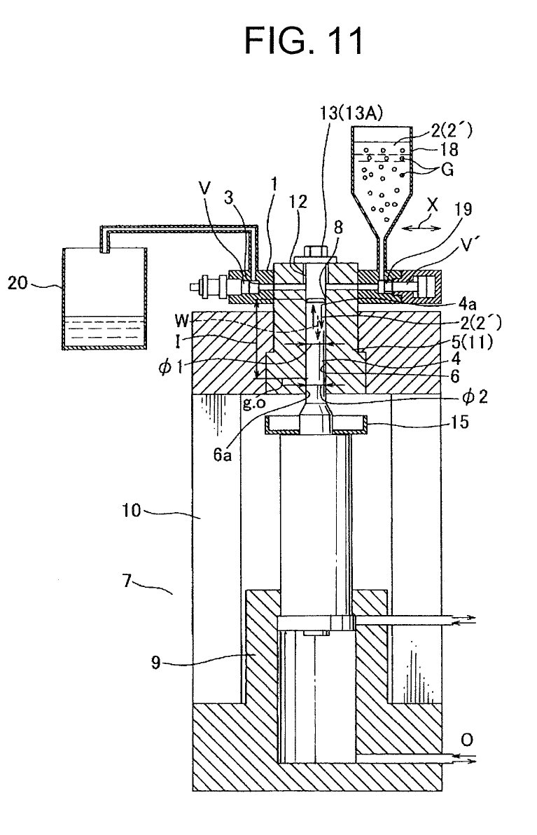

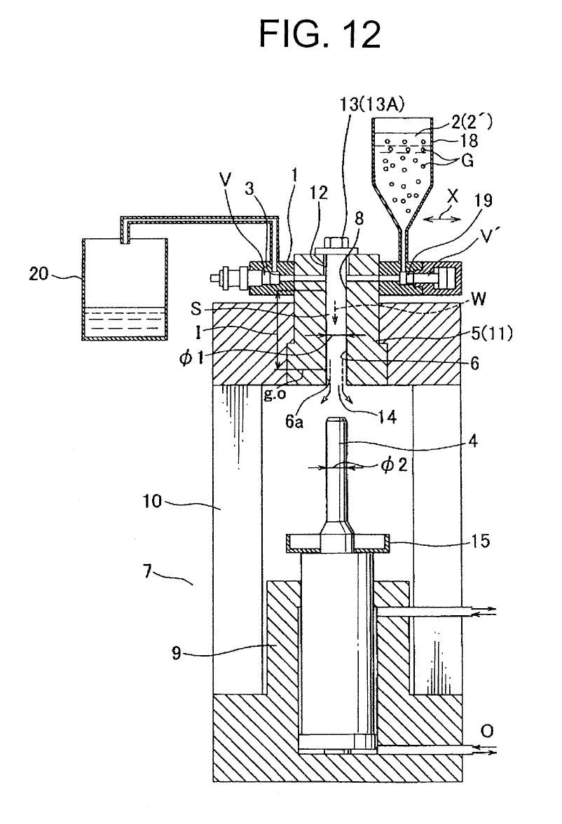

A third embodiment of the high-pressure homogenizing apparatus according to the present invention is shown in FIGS. 10-12. In the first embodiment, the high-pressure homogenizing mechanism 1 of the high-pressure homogenizing apparatus, the material receiving passage 8 in communication with the material processing recess 6 and the cleaning liquid inlet 12 openable by the open/close device 13 is arranged at a center, and the material supply control valve 19 is arranged at a primary side of the material receiving passage 8. Thereby, the suspension 2 or the semifluid 2′ including the raw material G is supplied from the material supply hopper 18 through the material receiving passage 8 of the high-pressure homogenizing mechanism 1 into the material receiving recess 6. At the secondary side of the material receiving passage and the material processing recess 6, the orifice 3, which is pushed toward the valve seat VS to sustain the fine gap K by the homogenizing valve V moved freely linearly in the direction of X axis by the hydraulic cylinder, is formed integrally. The raw material G is passed through the orifice 3 and processed by the large difference of pressure. In the third embodiment, the material receiving passage 8 and the material receiving recess 6 are arranged in the center; and the material supply control valve 19 for supplying the suspension 2 and the semifluid 2′ including the raw material G from the material supply hopper 18 to the material receiving passage 8 and the material processing recess 6 is arranged at the primary side; and the high-pressure homogenizing mechanism 1 having the orifice processing the raw material G by the large difference of pressure is arranged the secondary side separately from the material supply control valve. Thereby, the high-pressure homogenizing mechanism 1 is structured simple, so that manufacturing process and assembling process are simplified and repairing and replacing parts in case of malfunctions, and maintenance could be simplified. The raw material G is passed through the gap K of the orifice 3 so as to be subdivided and high-pressure homogenized by the large difference of pressure. When the material processing recess 6 and the material receiving passage 8 in communication with the material processing recess 6 of the high-pressure homogenizing apparatus are cleaned with the cleaning liquid W, the driving stroke of the material processing piston 4 is adjusted corresponding to the cleaning level so as to generate the space S larger than the volume of the driving stroke I by the normal driving. The first method is as shown in FIG. 10 that, when the cleaning is acted after the operation of subdividing or high-pressure homogenizing the raw material G, or simple cleaning is acted with a predetermined period, weekly or monthly or periodically, the material processing piston 4 is moved in the material processing recess 6 to the most retracted position g.o near to the open end 6a of the material processing recess 6, and the cleaning is acted without disassembling/reassembling. The second method is that, when the complete cleaning is acted, the inside of the material processing recess 6 is cleaned in a condition of the pressurizing mechanism 7 disassembling/reassembling that the material processing piston 4 is moved back and pulled out from the open end 6a of the material processing recess 6 (shown in FIG. 12). Thus, other than having the first and second method, the embodiment includes the same structure and actions as the first embodiment.

### Fourth Embodiment

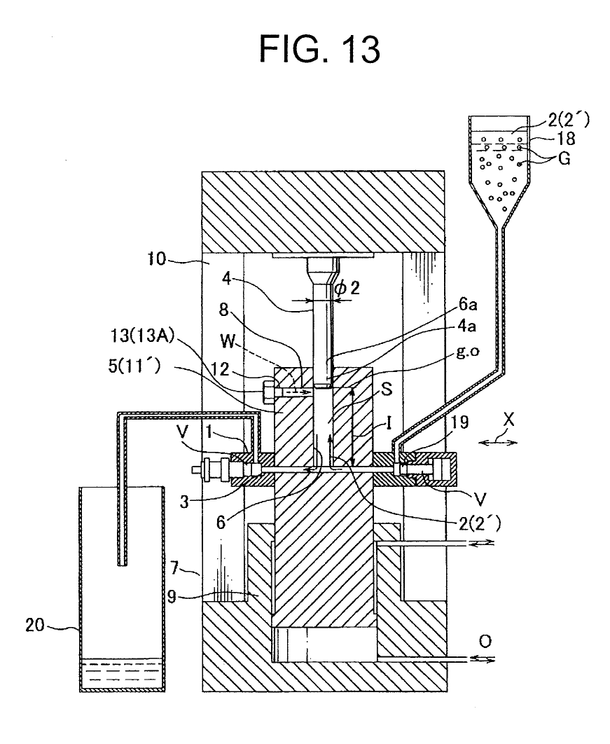

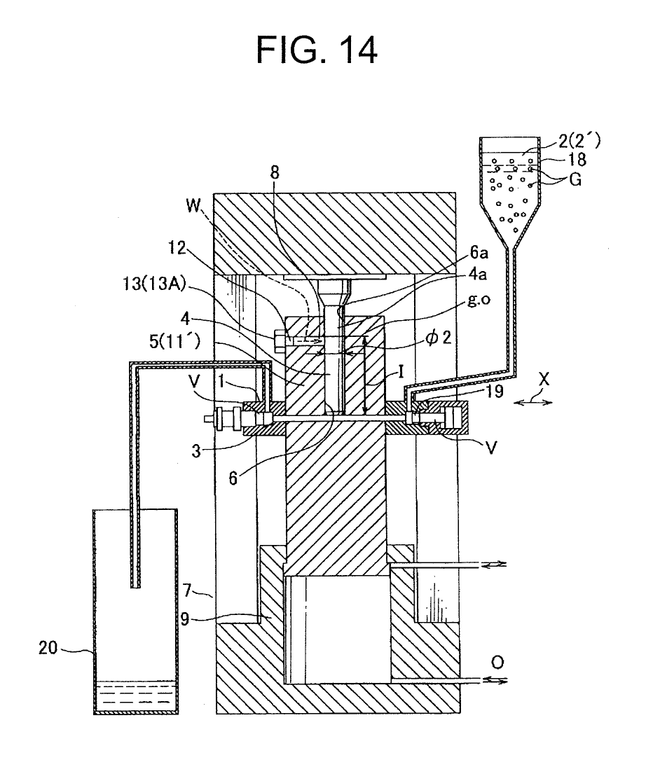

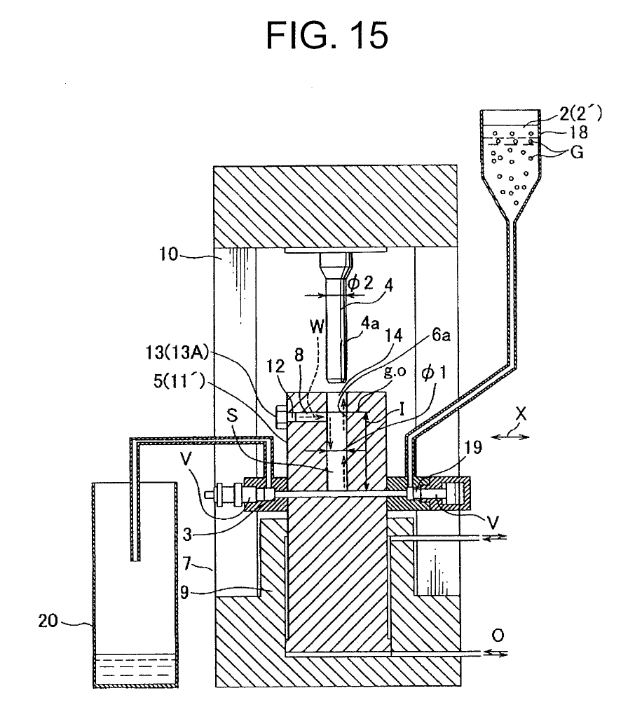

A fourth embodiment of the high-pressure homogenizing apparatus according to the present invention is shown in FIG. 13-15. In the fourth embodiment, the high-pressure homogenizing apparatus subdivides or homogenizes the suspension 2 or the semifluid 2′ including the raw material G by one of fine solid matter and the fiber cellulose by passing the suspension 2 or the semifluid 2′ through the orifice 3 of the high-pressure homogenizing mechanism 1; and includes the material processing piston 4, the material processing recess 6 provided at the inserting member 5 so as to insert the top end 4a of the material processing piston 4 therein, the pressurizing mechanism 7 pressurizing the material processing piston 4 or the inserting member 5, the material receiving passage 8 communicating between the material processing recess 6 and the high-pressure homogenizing mechanism 1. Thus, other than that, the fourth embodiment includes the same structure and actions as the first embodiment, the second embodiment and the third embodiment.

In the first, second, or third embodiment, it is designed that one of the inserting member 5 and the material processing piston 4, for example the material processing piston 4 moves against, the other, for example, the inserting member 5. Thereby, the suspension 2 or the semifluid 2′ including the raw material G in the receiving passage 8 is transferred by pressure generated by volume reduction of the material processing recess 6 to the high-pressure homogenizing mechanism 1 having the orifice 3; and subdivided and processed. When the material processing piston 4 is move back over the most retracted position g.o near to the open end 6a of the material processing recess 6 in normal driving, the cleaning liquid W is led from the cleaning liquid inlet 12 through the material receiving passage 8 into the material processing recess 6, so that the inside of the material processing recess is cleaned. Oppositely, in the fourth embodiment, the inserting member 5 is provided movably against the material processing piston 4 fixed at a top of the base frame 10 as a movable cylinder 11′ of the pressurizing mechanism 7. When the most retracted position g.o near to the open end 6a of the material processing recess 6, the movable cylinder 11′, is moved to the top end 4a of the material processing piston 4, the inside of the material processing recess 6 is cleaned.

When the periodical simple cleaning is acted, firstly, the movable cylinder 11′ as the inserting member 5 is moved back so as to position the most retracted position g.o near to the open end 6a of the material processing recess 6 at the top end 4a of the material processing piston 4, so that the wide space S larger than the volume of the normal driving stroke I of the material processing piston 4 in the material processing recess is generated. The cleaning liquid inlet 12 is opened by operating the open/close device 13. The cleaning liquid W is led from the cleaning liquid inlet 12 through the material receiving passage 8 into the material processing recess 6. Thereby, in a condition that the material processing piston 4 is sustained to be inserted in the material processing recess 6 without pulling the material processing piston 4 out from the most retracted position g.o near to the open end 6a of the material processing recess 6, the material receiving passage 8 in communication with the gap of the orifice 3 at the high-pressure homogenizing apparatus and the inside of the material processing recess 6 can be cleaned rapidly and securely by wiping out the raw material G with the cleaning liquid W by a brush without disassembling the pressurizing mechanism 7 and reassembling the pressurizing mechanism 7. Thus, the material receiving passage 8 in communication with the orifice 3 at the high-pressure homogenizing mechanism 7 and the inside of the material processing recess 6 can be cleaned, so that the orifice 3 can be prevented from blocking and the fine gap K of the orifice 3 can be maintained easily and securely, and it can contribute to effectively subdivide and high-pressure homogenize the raw material.

### INDUSTRIAL APPLICABILITY

According to the present invention, by simple operation of moving one of the material processing piston and the inserting member relatively to each other and leading the cleaning liquid from the outside, the inside of the material processing recess can be cleaned easily and securely without almost whole disassembling/reassembling. Thereby, the high-pressure homogenizing apparatus can be sanitary; and have good maintainability and sustain a fine gap of the orifice securely without blocking the orifice so that it can contribute to effectively subdivide and high-pressure homogenize the raw material.

1. A high-pressure homogenizing apparatus, for subdividing/homogenizing one of a suspension and a semifluid including a raw material structured with at least one of fiber cellulose and fine solid matter by passing one of the suspension and the semifluid through an orifice of a high-pressure homogenizing mechanism, comprising:
a material processing piston;
a material processing recess provided at an inserting member so as to insert a top end of the material processing piston therein;
a pressurizing mechanism pressurizing one of the material processing piston and the inserting member; and
a material receiving passage communicating between the material processing recess and the high-pressure processing mechanism,
wherein the one of the suspension and the semifluid including the raw material is transferred by pressure into the material receiving passage by volume reduction resulted by relative motion of the inserting member and the material processing piston, and the raw material is subdivided/homogenized,
wherein an inside of the material receiving recess is cleaned by supplying a cleaning liquid from the material receiving passage into the material receiving recess when the material processing piston moves back over an open end of the material processing recess.

2. The high-pressure homogenizing apparatus according to claim 1, wherein the material processing piston is arranged movably against the inserting member so as to clean the inside of the material processing recess when the material processing piston is moved to a most retracted position near to the open end of the material processing recess.

3. The high-pressure homogenizing apparatus according to claim 1, wherein a movable cylinder of the pressurizing mechanism is arranged as the inserting member movably against the material processing piston, which is fixed, so as to clean the inside of the material processing recess when an open end of the material processing recess is moved back to a most retracted position against a top end of the material processing piston.

4. The high-pressure homogenizing apparatus according to claim 1, 2 or 3, wherein the inside of the material processing recess is cleaned when the material processing piston is moved back and pulled out from the open end of the material processing recess.

5. The high-pressure homogenizing apparatus according to claim 1 or 2, wherein the material processing recess is arranged at a cylinder, as the inserting member, fixed at a base frame, and the material processing piston is inserted movably into the material processing recess by the pressurizing mechanism.

6. The high-pressure homogenizing apparatus according to claim 1 or 2, wherein the material processing recess is arranged at a cylinder, as the inserting member, fixed at the longitudinal base frame, and the material processing piston is inserted movably into the material processing recess by the pressurizing mechanism, and a liquid pool member with a dish-shaped cross-section is arranged to be fitted around a lower step at a middle portion of the material processing piston, the lower step facing the open end of the material processing recess.

7. The high-pressure homogenizing apparatus according to claim 1 or 2, wherein the material processing recess is arranged at a cylinder, as the inserting member, fixed at a longitudinal base frame, and the material processing piston is inserted movably into the material processing recess by the pressurizing mechanism.

8. The high-pressure homogenizing apparatus according to claim 1 or 2, wherein the cleaning liquid is supplied to the material receiving recess through a cleaning liquid inlet, which is arranged openably by an open/close device so as to communicate with the material receiving passage, and from the cleaning liquid inlet through the material processing recess in communication with the material receiving passage.

9. The high-pressure homogenizing apparatus according to claim 1 or 2, wherein the cleaning liquid is as one selected among from cleaning water, a disinfectant, and an organic solvent.

10. The high-pressure homogenizing apparatus according to claim 1 or 2, wherein a seal assembly supporting the material processing piston movably and water-tightly is arranged in the material processing recess, and assembled by piling a plurality of gaskets.

11. The high-pressure homogenizing apparatus according to claim 1 or 2, wherein the material processing piston is inserted slidably in the seal assembly and the seal assembly is fixed and received in the material processing recess.

12. The high-pressure homogenizing apparatus according to claim 1 or 2, wherein the seal assembly is received and fixed in the material processing recess and the material processing piston is inserted and supported slidably through the seal assembly.
